(19) United States
(12) Patent Application Publication
(10) Pub. No.: US 2023/0089788 A1
(43) Pub. Date: Mar. 23, 2023

(54) Unidirectional Or Bidirectional Rotary Drive

(71) Applicant: SEB S.A., Ecully (FR)

(72) Inventors: David Benoit, Ecully (FR); Stéphane Plichon, Ecully (FR)

(73) Assignee: SEB S.A., Ecully (FR)

(21) Appl. No.: 17/950,345

(22) Filed: Sep. 22, 2022

(30) Foreign Application Priority Data
Sep. 23, 2021 (FR) 2110039

(51) Int. Cl. A47J 43/08; B01F 35/31; B01F 35/33; B01F 35/32; A47J 43/044

(52) U.S. Cl. CPC A47J 43/082; B01F 35/31; B01F 35/332; B01F 35/3202; B01F 35/3214; A47J 43/044; B01F 2101/1805

(57) ABSTRACT

A rotary drive device for a mixing or grinding cooking appliance includes (i) a rotary subassembly, (ii) a rotary drive member of a food processing arm and, (iii) a rotary coupling member of the rotary subassembly with the drive member for transmitting a rotational movement from the rotary subassembly the drive member. The coupling member is movable between a first position in which the coupling member is adapted to transmit motion in a single direction of rotation of the rotary subassembly and a second position in which the coupling member is adapted to transmit motion in two directions of rotation of the rotary subassembly.

### FIELD OF INVENTION

The present invention relates to the field of manual cord-driven devices for kitchen appliances used in cutting, mixing or grinding.

### STATE OF THE ART

Many cooking appliances for mixing or chopping are known from the state of the art. In particular, there is a distinction between electrical appliances in which a drive using an electric motor rotates a tool, which can be a knife or a mixing arm.

The main advantage of electric drive devices is that they provide constant torque and variable speed of rotation that is directly dependent on the rotation speed of the electric motor.

These electric drive devices offer a very advantageous high torque and speed of rotation. Nevertheless, they require connection to an electrical outlet, they consume energy, and most importantly, they are prone to electric motor failures. Moreover, it is frequently less expensive to change the entire drive device rather than to repair it, which is wasteful. Cooking appliances with electric drive therefore have the double disadvantage of being energy-consuming and wasteful.

In this context, manual drive devices are reviewed. Thus, in a conventional way, we are familiar with the salad spinner, whose basket is rotated by a cord unwound by the user and then wound by a return spring. On this principle, many drive devices have been proposed.

Examples include document US 2009/0178580, which describes a set of knives driven in a bowl by the manual drive device for chopping food. The device described in this document has the disadvantage that the torque transmitted to the set of knives cannot be optimally adapted to the cutting or mixing tool. For example, when cutting onions or apples, at the beginning of the movement, when the food is roughly cut and bulky, more torque needs to be applied than at the end of the process, because these foods have more resistance to cutting. Later, during the cutting process, when the food is finer and less bulky, greater speed and momentum in the bowl is desired. To do this, in order to mix the pieces, the speed of rotation must be increased and the torque reduced. Indeed, in the case of manual transmission of a movement, in a known manner, torque and rotation speed are two opposing parameters. To increase torque, the speed must be reduced, and vice versa.

Also known is document WO 2006/114252, which describes a centrifuge for a drying device in which a manual spindle drive device is used. In this centrifuge, a spindle nut in contact with the threads of a spindle is moved along its longitudinal axis relative to the spindle. The threading of the spindle is constant over the full length of the spindle thread pitch. The movement of the spindle nut relative to the spindle causes the spindle and a shaft bearing the spindle, which is coupled to a mop, to rotate around the longitudinal axis. However, this drive device has constant torque and rotational speed.

Document DE 580073 describes a mixing and beating machine for bakeries, with a continuously variable speed. Although this machine allows for a change of speed, the gearbox is designed for a machine that needs to be manually switched. Therefore, the operator must manually adjust the speed by operating a gearbox.

Document FR 2 532 540 describes a device for making and mixing sauces. Although the drive on this device has a gear train to change the speed of rotation, the gear ratio is fixed and torque can only vary by varying the force applied externally. The same is true for the manual food chopping machine described in document WO 2004/073474, which also includes gearing in a lid that rotates a cutting tool in the form of a set of knives.

The food chopper known from EP 2015660 B1 can also be cited. By pulling on a cord, the user can activate the moving parts of the cord-pull unit. A cord drum is driven directly by the cord. It is coupled in one direction of rotation via a freewheel clutch with a connecting element. In turn, a flange of the column of knives can be inserted into the connecting element to produce a positive connection in the direction of rotation. Pulling the cord rotates the knife column. The attached knives strike the food in the container to be cut and cut it up.

Similarly, with the food chopper known from DE102013112225, by pulling a cord, the user can activate moving parts of the cord drive unit. A cord drum is driven directly by the cord and is positively coupled in the connecting element in one direction of rotation and decoupled in the other direction of rotation of the connecting element. A transmission of at least two stages is formed between the cord drive unit and the rotary connecting element, which is switchable between a low-speed cutting mode and a precise cutting mode having a higher speed than the low-speed cutting mode.

In the other direction of rotation, the knife column is decoupled via the freewheel clutch of the cord drive, so that the cord can be pulled excessively without incident. In the cord drive unit, a spring return is designed to retract the cord pulled by the user and thus prepare for the next pulling movement.

However, it has been shown that it is desirable to be able to accelerate the rotation speed of the mixer drive shaft for more efficient mixing. For mixing, a high angular speed of the mixer drive shaft is desirable, so the number of revolutions per minute increases, allowing for faster mixing. However, to do this, the user must pull the cord forcefully and very quickly, given the gear ratio of the drive device. For grinding, a higher cutting force is required, because the material to be cut is initially unmilled and can be hard. If the food preparation to be mixed is liquid or composed of smaller, softer pieces, the required force is reduced and the speed can be increased. However, it is possible to use the mixer drive shaft at reduced speed and increased torque if the texture of the mixture proves to be so dense that the cord return would be prevented due to insufficient force of the return spring. It is also possible to use the high rotation speed with the cutting drive shaft if the materials are thin enough to provide less resistance and allow the knives to go back without applying a lock that would prevent the cord from retracting.

In this context, a drive device for a mixing or grinding cooking appliance needs to be provided that makes it possible to alternate simply between a unidirectional rotation and a bidirectional rotation.

### DISCLOSURE OF THE INVENTION

According to a first aspect, the invention proposes a rotary drive device for a mixing or grinding cooking appliance, the drive device comprising,

(i) a rotary subassembly,
(ii) a rotary drive member of a food processing arm, and
(iii) a rotary coupling member of the rotary subassembly with the drive member for transmitting rotational movement from the rotary subassembly to the drive member. In addition, the coupling member is movable between a first position in which the coupling member is adapted to transmit motion in a single direction of rotation of the rotary subassembly and a second position in which the coupling member is adapted to transmit motion in two directions of rotation of the rotary subassembly.

The coupling member may comprise a ratchet wheel portion allowing motion to be transmitted in a single direction of rotation.

The drive device may comprise a first coupling element rotationally connected to the rotary subassembly and suitable for being coupled to the ratchet wheel portion of the coupling member.

The coupling member may comprise a dog clutch portion for allowing movement to be transmitted in two directions of rotation.

The drive device may comprise a second coupling element suitable for being mated to the dog clutch portion of the coupling member, in order to be rotatably connected to the drive member.

The drive device may comprise two-stage gearing interposed between the first coupling element and the second coupling element, in order to modify a torque and rotational speed of a motion transmitted from the first coupling element to the second coupling element, when the second coupling element is coupled to the dog clutch portion of the coupling member.

The coupling member can be movable in translation between the first position and the second position.

The drive device may comprise a lever allowing the coupling member to be moved in translation between the first position and the second position.

At least one elastic member can exert a force on the lever to automatically position it in the first position.

An actuator can be adapted to position and hold the lever in the second position.

The rotary subassembly may comprise a reel comprising a cord and a return spring, the reel driving the subassembly in rotation.

According to another aspect, the invention relates to a mixing or grinding cooking appliance comprising a drive device according to any one of the preceding claims.

The cooking appliance may include a bowl and a lid suitable for closing the bowl, as the drive device may be contained in the lid.

The cooking appliance may comprise a removable food processing arm for mixing or grinding, the food processing arm being connected to the drive member of the drive device.

### DESCRIPTION OF THE FIGURES

Other features, purposes and benefits of the invention will emerge from the following description, which is purely illustrative and not exhaustive, and which must be read in relation to the attached drawing on which:

FIG. 1 is an exploded depiction in perspective of a drive device according to the invention.

FIG. 2 is an exploded side depiction of a drive device according to the invention.

FIG. 3 is an exploded partial depiction in perspective of a drive device according to the invention.

FIG. 4 is an exploded partial depiction in perspective of a drive device according to the invention.

FIG. 5 is a cross-sectional depiction of a drive device according to the invention.

FIG. 6 is a double cross-sectional depiction of a drive device according to the invention, when the coupling member is in a first position.

FIG. 7 is a double cross-sectional depiction of a drive device according to the invention, when the coupling member is in a second position.

FIG. 8 is a depiction in perspective of a lid of a cooking appliance according to the invention.

FIG. 9 is a depiction in perspective of a cooking appliance according to the invention.

### DETAILED DESCRIPTION OF THE INVENTION

### Drive Device

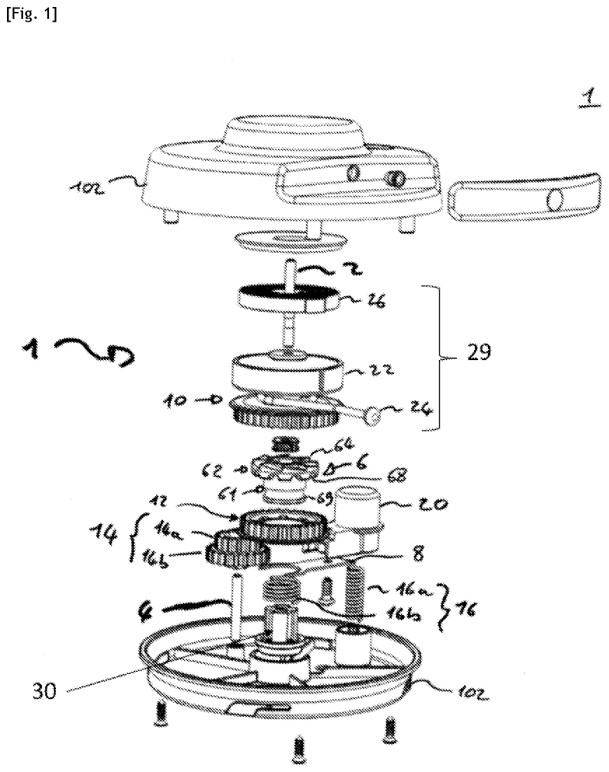

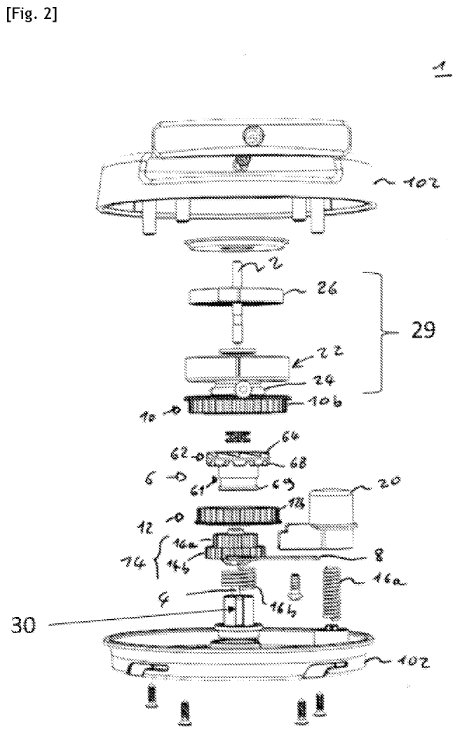

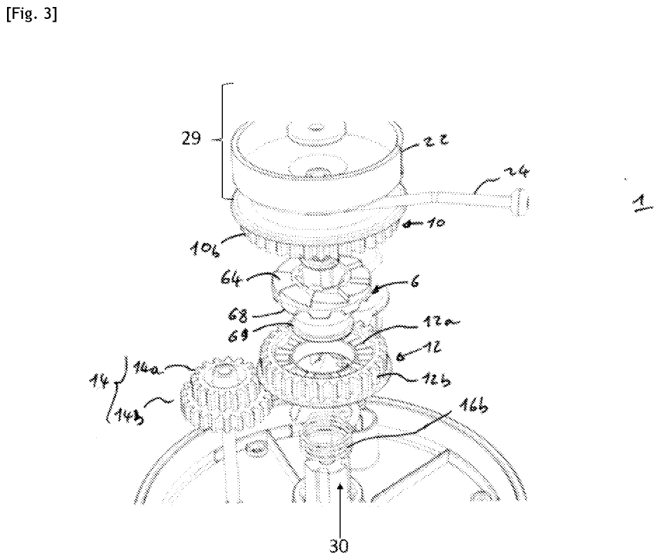

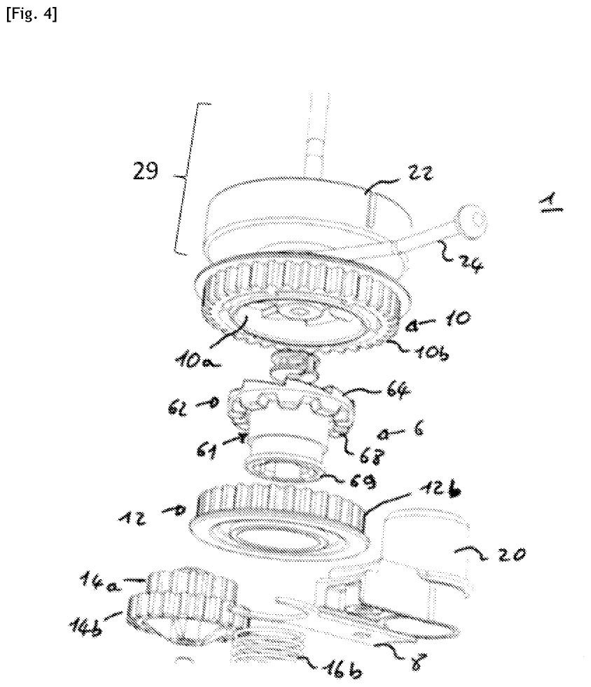

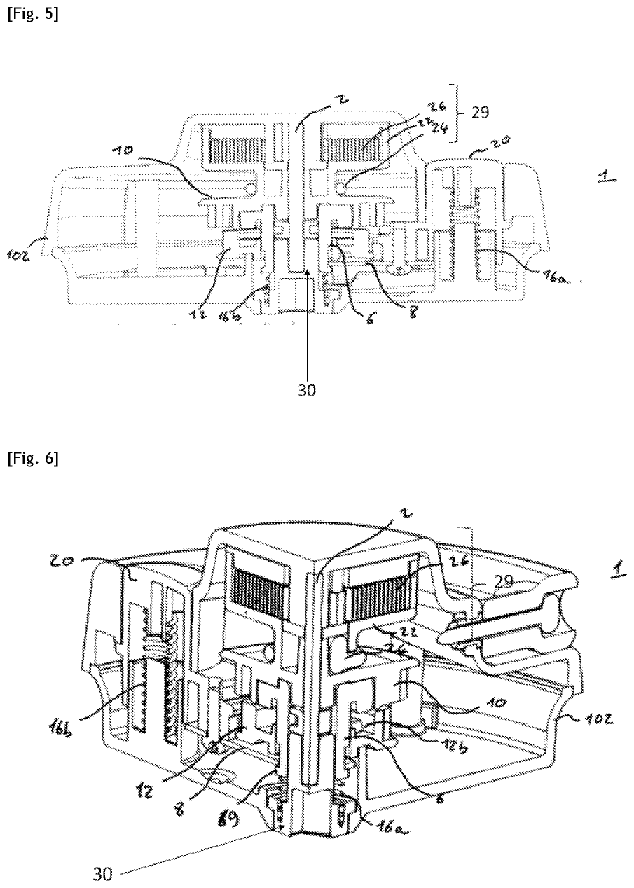

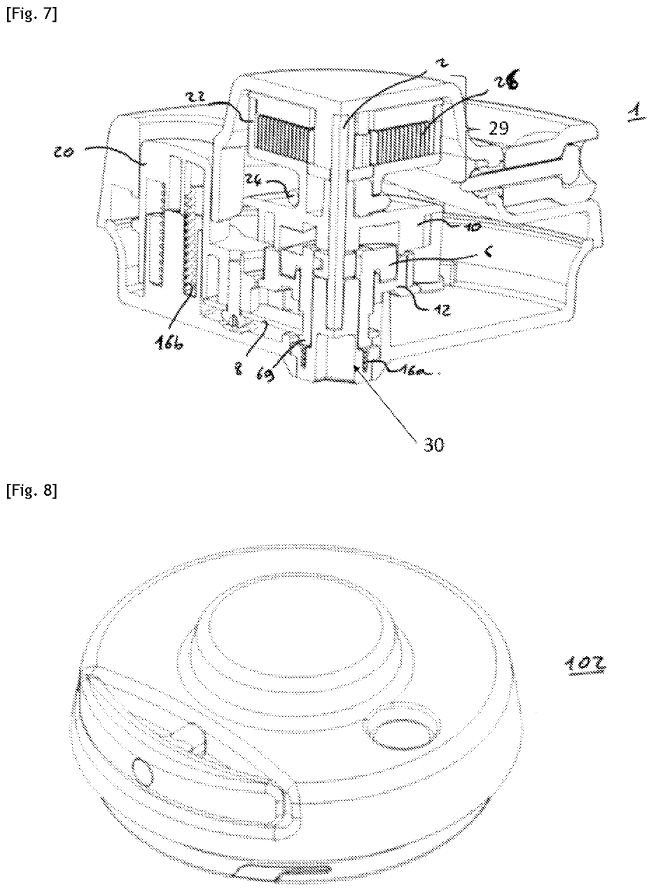

According to a first aspect, with reference to FIGS. 1 to 7, the invention proposes a rotary drive device 1 for a mixing or grinding cooking appliance.

The drive device 1 mainly comprises,

(i) a rotary subassembly 29,
(ii) a rotary drive member 30 of a food processing arm, and
(iii) a rotary coupling member 6 of the rotary subassembly 29 with the drive member 30 for transmitting a rotational movement from the rotary subassembly 29 to the drive member 30.

The coupling member 6 is movable between a first position in which the coupling member 6 is suitable for transmitting motion in a single direction of rotation of the rotary subassembly 29 and a second position in which the coupling member 6 is adapted to transmit motion in two directions of rotation of the rotary subassembly 29.

Thus, the coupling member 6 very advantageously makes it possible to change the transmission mode to allow unidirectional rotation or bidirectional rotation. In other words, as will be detailed hereinafter, a simple movement of the coupling member 6 makes it possible to change from a first unidirectional rotation position to a second bidirectional rotation position and vice versa. This arrangement very advantageously enables the drive device 1 to be particularly versatile and able to be used both for chopping and mixing. Indeed, to chop large elements, a unidirectional rotation is often preferred, and a bidirectional rotation will often be preferred for mixing.

### Rotary Subassembly

The drive device 1 comprises a rotary subassembly 29.

Typically, the rotary subassembly 29 is a reel comprising a cord 24, of which one end is wound around a drive wheel 22 and of which the other end is connected to a handle, and a return spring 26. The rotary sub-assembly 29 advantageously comprises a take-up drum or a drive wheel 22 comprising a groove where the cord 24 fits by wrapping around the rotation axis. The drive wheel 22 is a known element that goes into rotation through pulling on a cord 24. When a user pulls the handle connected to the cord 24, the cord is completely unwound, then the return spring 26 allows the drive wheel 22 to turn in the reverse direction and thus rewind the cord 24. It should be noted that the rotation caused by the return spring 26 is reverse to that of the rotation caused by the cord 24.

The drive wheel 22 of the drive device 1 has a cavity intended to receive the return spring 26. Advantageously, the cord 24 is wound in the groove of the drive wheel 22, counter-clockwise with respect to the axis of rotation and the return spring 26 is arranged in the cavity of the drive wheel 22 wound clockwise with respect to the axis of rotation. It may be considered that the cord 24 is wound in the groove of the drive wheel 22, clockwise relative to the axis of rotation, and the return spring is disposed in the cavity of the drive wheel 22 wound counter-clockwise relative to the axis of rotation.

The rotary subassembly 29 is rotatably linked to a first coupling element 10.

According to the embodiment shown here, the first coupling element 10 shown here is part of the rotary subassembly 29 (it is the same part). However, the rotary subassembly 29 and the first coupling element 10 may also be two separate parts attached to one another.

### First Coupling Element

The drive device 1 comprises a first coupling element 10 that enables a rotational movement of the rotary subassembly 29 to be transmitted to the coupling member 6 (when the coupling member 6 is in a first position) or to a second coupling element 12 (when the coupling member 6 is in a second coupling position).

According to the embodiment shown here, the first coupling element 10 is in the form of a wheel with two faces and an edge. One face 10a has a ratchet wheel. The edge 10b has teeth suitable for engaging gearing 14, which will be described hereinafter. The teeth of the edge 10b can be straight or helical teeth.

As will be described hereinafter, the face 10a of the first coupling element 10 is suitable for transmitting a rotational movement for a single direction of rotation to the ratchet wheel 64 of the coupling member 6. Thus, in a first direction of rotation of the face 10a, the first coupling element 10 drives the ratchet wheel 64 in rotation. In a second direction of rotation of the face 10a, the coupling between the ratchet wheel 64 and the first coupling element 10 is not possible, and there is no transmission of rotation.

In addition, as will be described hereinafter, the edge 10b allows for a bidirectional rotational movement (i.e. regardless of the direction of rotation) to be transmitted to gearing 14.

The first coupling element 10 may be made of metal (such as steel, stainless steel, or aluminum), polymeric material, or composite material.

### Coupling Member

With reference to FIGS. 1 to 7, the coupling member 6 is in the form of a revolution part having a T-shaped cross section. In other words, and very broadly speaking, the coupling member 6 has an axial shaft portion 61 and a transverse wheel 62.

In addition, the coupling member 6 is hollow to accommodate the drive member 30. Typically, the coupling member 6 may have a bore with splines in order to have a splined connection with the drive member 30. Indeed, the splines are particularly suitable for transmitting rotational torque.

According to a particularly advantageous arrangement, the coupling member 6 comprises a ratchet wheel portion 64 allowing movement to be transmitted in only one direction of rotation. Preferably, the transverse wheel 62 comprises the ratchet wheel portion 64.

It is recalled that a ratchet wheel is a non-return device forcing a rotary mechanism to rotate in only one direction. This wheel has notches all around the periphery thereof, causing a ratchet (or a complementary ratchet wheel) to be lifted in the desired direction to allow it to pass but blocked by it in the other direction. In a known way, ratchet wheels are found in freewheel mechanisms.

The ratchet wheel portion 64 is suitable for cooperating with the ratchet wheel of the face 10a of the first drive element 10, when the coupling member 6 is in a first coupling position.

Furthermore, according to a particularly advantageous arrangement, the coupling member 6 comprises a dog clutch portion 68 allowing movement to be transmitted in two directions of rotation. Preferably, the transverse wheel 62 comprises the dog clutch portion 68.

It is recalled that, according to a commonly accepted definition, a dog clutch is the direct coupling of two metal parts by teeth and grooves. In other words, a dog clutch system is a mechanical system that interconnects two rotary parts by dog clutch, interconnect being understood as the two parts being joined in rotation so as to form only one movable rotary mechanical assembly.

As will be described below, the dog clutch portion 68 is suitable for cooperating with a second coupling element that will be described hereinafter, when the coupling member 6 is in a second coupling position.

According to a preferential arrangement, the ratchet wheel portion 64 and the dog clutch portion 68 both make up the transverse wheel portion 62. More specifically, according to the embodiment shown in FIGS. 1 to 7, the ratchet wheel portion 64 and the dog clutch portion 68 each constitute one face of the transverse wheel 62. According to this embodiment, the ratchet wheel portion 64 and the dog clutch portion 68 are axially opposite. As will be described hereinafter, this is an advantageous arrangement making it possible to switch from a unidirectional rotation mode to a bidirectional rotation mode by a simple translation of the coupling member 6.

In addition, the coupling member 6 comprises a flange 69 positioned at one end of the shaft portion 61. As will be described hereinafter, the flange 69 is suitable for cooperating with a lever 8.

The coupling member 6 may be made of metal (such as steel, stainless steel, or aluminum), polymeric material, or composite material.

### Drive Member

The drive member 30 is a revolution part having a splined outer surface designed and configured to be inserted into a bore of the coupling member 6. As mentioned earlier, splines are a particularly advantageous arrangement, allowing for optimal transmission of torque. It should be noted that the splined connection secures the drive member 30 in rotation with the coupling member 6.

In addition, the drive member 30 has a prismatic footprint suitable for receiving one end of a food processing arm.

For example, the prismatic footprint may be hexagonal, this geometry being particularly suitable for transmitting torque and rotational movement.

### Second Coupling Element

The drive device 1 comprises a second coupling element 12 that allows for a rotation of the first coupling element 10 to be transmitted to the coupling member 6, when the coupling member 6 is in a second position.

The second coupling element 12 is an additional rotational transmission member of the dog clutch 68. In other words, the second coupling element 12 is suitable for transmitting a rotational movement for both directions of rotation of the dog clutch 68. Thus, when mated to the dog clutch 68, the coupling element 10b transmits the rotation to the coupling member 14, 14a being engaged with 10b and 14b being engaged with 12b, thus 12 is driven in rotation in turn, the second coupling element 12a drives the dog clutch 68 in rotation and transmits this rotational movement, regardless of the direction of rotation of the dog clutch 68 (and therefore, the drive member 30).

Typically, the second coupling element 12 may have an additional dog clutch portion of the dog clutch 68.

According to the embodiment shown here, the second coupling element 12 is in the form of a wheel with two faces and an edge. One face 12a is suitable for being mated to the dog clutch 68. The edge 12b has teeth suitable for engaging gearing 14 which will be described hereinafter. The teeth of edge 12b can be straight or helical teeth.

The second coupling element 12 may be made of metal (such as steel, stainless steel, or aluminum), polymeric material, or composite material.

### Centering

The rotary subassembly 29, the first coupling element 10, the coupling member 6, the second coupling element 12 and the drive member 30 are rotary movable parts.

According to the embodiment shown here, these parts are movable in rotation around the same axis of rotation and are stacked on a primary shaft 2. It should be noted that according to the example shown here, the primary shaft 2 is fixed and does not transmit any torque. Thus, according to the embodiment shown here, the primary shaft 2 only has a centering and rotational guide function.

### Gearing

According to the embodiment shown here, the drive device 1 comprises gearing 14 positioned on a secondary shaft 4. Like the primary shaft 2, the secondary shaft 4 is fixed and simply provides a rotational centering function for the gearing 14.

The gearing 14 makes it possible to rotationally connect the first coupling element 10 and the second coupling element 12, when the coupling member is in the second coupling position.

In addition, the gearing 14 makes it possible to modify a torque and a rotation speed of a movement transmitted from the first coupling element 10 to the second element 12.

More specifically, the gearing 14 consists of two gear wheels 14a and 14b axially stacked with respect to the secondary shaft 4.

A first gear wheel 14a is suitable for being engaged with the first coupling element 10, and more specifically, with the edge 10b of the first coupling element 10.

A second gear wheel 14b is suitable for being engaged with the second coupling element 12, and more specifically with the edge 12b of the second coupling element 12.

In a particularly advantageous manner, the first gear wheel 14a and the second gear wheel 14b may have different diameters. This arrangement allows for a different transmission ratio between the two gear wheels. Thus, the first coupling element 10 is engaged with the first gear wheel 14a, the rotation speed and the torque transmitted by the second gear wheel 14b to the second coupling element 12. The difference in diameter between the first gear wheel 14a and the second gear wheel 14b makes it possible to change the rotation speed and the transmitted torque.

Typically, the gearing 14 is chosen to allow for an increase in the rotation speed, such that the rotation speed of the second coupling element 12 is greater than the rotation speed of the first coupling element 10.

Thus, in other words, the gearing 14 in combination with the first coupling element 10 and the second coupling element 12 forms a gearbox.

### Means of Changing Position

As previously indicated, the coupling member 6 is movable in translation between two coupling positions.

The displacement and holding in position of the coupling member 6 is made possible by displacement means.

According to the embodiment presented here, the means of displacement comprise at least one elastic member 16, a lever 8 and an actuator 20.

According to the example shown here, the means of displacement comprise two elastic members 16a and 16b.

In addition, according to the example shown here, the elastic members 16a and 16b are coil springs. Similarly, the actuator 20 may be a push button.

As shown in the figures, the lever 8 is attached to the actuator 20 by a screw. Thus, the lever 8 and the actuator 20 are secured in translation.

One end of the lever 8 is in the form of a two-pronged fork. This end is suitable for being positioned against the flange 69 in order to translationally move the coupling member 6 between the first coupling position and the second coupling position.

More specifically, a user pressing on the actuator enables the lever 8 to be moved in translation in order to change from the first coupling position to the second coupling position.

The two elastic members 16a and 16b are positioned in such a way as to counteract the movement of the actuator. Thus, the two elastic members 16a and 16b hold the lever 8 in the first coupling position. In other words, the elastic members 16a and 16b hold the lever 8 in the first position (i.e., a user must hold the actuator 20 down in order to position and hold the lever in the second position. Again in other words, the elastic members 16a and 16b exert a force on the lever 8 to automatically position it in the first position

### Cooking Appliance

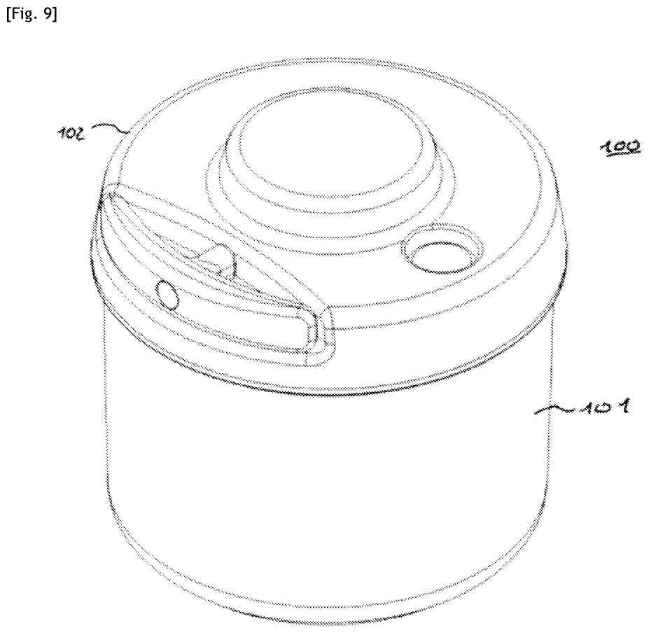

According to a second aspect, as shown in FIGS. 8 and 9, the invention also concerns a mixing and/or a grinding cooking appliance 100, comprising a drive device 1 according to the invention.

The cooking appliance 100 comprises a bowl 101 and a lid 102 designed and configured to close the bowl 101.

According to the embodiment presented herein, the drive device 1 is contained in the lid 102.

In addition, the cooking appliance 100 may comprise a food processing arm for mixing or grinding. A food processing arm is positioned in the bowl 101 and is connected to the drive member 30 of the drive device 1.

### Operation

The operation will now be described by considering that the drive device 1 is incorporated into a cooking appliance 100. Of course, the operation of the drive device 1 does not change, whether or not it is incorporated into a cooking appliance 100.

As previously indicated, the lever 8 naturally positions the coupling member 6 in the first coupling position (default). In this position, only unidirectional rotation is allowed.

This position is best for cutting hard foodstuffs, such as hazelnuts. Thus, to cut hard foodstuff, a user will typically connect a processing arm with sharp blades to the drive member 30.

Then, the user can grasp the handle and pull the cord 24 to rotate the rotary subassembly 29.

The rotation of the rotary subassembly 29 is directly transmitted to the coupling member 6 via the face 10a in contact with the face 64.

Thus, in the case of rotation transmitted by pulling on the cord, the first coupling element 10 drives the coupling member 6 in rotation, which is rotationally secured to the drive member 30, and the drive member 30 drives in rotation a set of knives (or another culinary tool of a food processing arm).

Once the cord is completely unwound, the user allows the return spring to rewind. The rotary subassembly 29 and the first coupling element 10 then rotate in reverse direction. When the coupling member 6 is in the first coupling position, the ratchet wheel 64 does not allow transmission of the rotational movement of the first coupling element 10 to the coupling member 6. This provision is particularly advantageous in the event that the user wishes to chop hard foods, because it is preferable that the blades of the processing arm rotate only under the action of pulling the cord 24 (maximum force) and disengage when the spring 26 rewinds the cord on 10. In addition, most processing arms with blades have only one cutting side.

As the chopping proceeds, the chopped pieces become smaller and smaller, so it may become beneficial to increase the speed of rotation of the knives. Similarly, when the cooking appliance is used to make a mixture or emulsion, the user will prefer to have a high tool rotation speed.

To do this, the user can press the actuator 20. When pressed, the actuator 20 moves the lever 8 in translation. Moving the lever 8 positions the cutting member 6 in the second coupling position. In this position, the dog clutch 68 of the coupling member 6 is mated to the second coupling element 12. As explained previously, coupling with dog clutch allows for a bidirectional rotation transmission.

In this configuration, the rotation of the rotary subassembly 29 is transmitted to the first coupling element 14a via the side faces 10b, the side faces 14b in turn transmit a rotational movement to the element 12 via the face 12b.

With the element 12 in rotation, the face 12a transmits a rotational movement to the part 6 via the face 68. The part 6, via the internal splines, ultimately transmits a rotational movement to the part 30, and therefore to the processing arm.

Irrespective of the direction of rotation of the rotary subassembly 29 (the direction of rotation of pulling of the cord or the reverse direction of rotation of the rewinding by the return spring), this rotational movement will be transmitted to the drive member 30. In other words, when the coupling member 6 is in the second coupling position, regardless of the direction of rotation of the rotary subassembly 29 and the coupling member 6, the rotation is transmitted to the second coupling element 12. In addition, as indicated previously, the reduction ratio of the connection between the side face 10b, the gearing 14 and the second coupling element 12 is chosen to favor a high speed (compared to the rotational speed obtained when the coupling member is in the first coupling position).

It should be noted that when the user releases the actuator 20, the elastic members 16a and 16b automatically reposition the coupling member 6 in the first coupling position.

This arrangement is particularly advantageous because it avoids potential confusion for the user. The user knows that by default, the coupling member 6 is in the first coupling position. In addition, this provision helps protect the equipment. Indeed, it is preferable to have a lower default rotation speed. If not, the equipment could be damaged if a user started chopping a large piece of meat at high speed. The processing arm would not have enough torque to cut the meat.

1. A rotary drive device for a mixing or grinding cooking appliance, the drive device comprising,
(i) a rotary subassembly,
(ii) a rotary drive member of a food processing arm and,
(iii) a rotary coupling member of the rotary subassembly with the drive member for transmitting a rotational movement from the rotary subassembly to the drive member, the device being characterized in that the coupling member is movable between a first position in which the coupling member is adapted to transmit motion in a single direction of rotation of the rotary subassembly and a second position in which the coupling member is adapted to transmit motion in two directions of rotation of the rotary subassembly.

2. The drive device according to claim 1, wherein the coupling member comprises a ratchet wheel portion for transmitting motion in a single direction of rotation.

3. The drive device according to claim 2, comprising a first coupling element rotationally connected to the rotary subassembly and suitable for being coupled to the ratchet wheel portion of the coupling member.

4. The drive device according to claim 1, wherein the coupling member comprises a dog clutch portion allowing movement to be transmitted in two directions of rotation.

5. The drive device according to claim 4, comprising a second coupling element suitable for being coupled to the dog clutch portion of the coupling member, in order to be rotationally connected to the drive member.

6. The drive device according to claim 5, comprising gearing in two stages interposed between the first coupling element, in order to modify a torque and rotational speed of a motion transmitted from the first coupling element to the second coupling element, when the second coupling element is coupled to the dog clutch portion of the coupling member.

7. The drive device according to claim 1, wherein the coupling member is movable in translation between the first position and the second position.

8. The drive device according to claim 7, comprising a lever allowing the coupling member to be moved in translation between the first position and the second position.

9. The drive device according to claim 8, wherein at least one elastic member exerts a force on the lever to automatically position it in the first position.

10. The drive device according to claim 8, wherein an actuator is adapted to position and hold the lever in the second position.

11. The drive device according to claim 1, wherein the rotary subassembly comprises a reel comprising a cord and a return spring, the reel driving the rotary subassembly in rotation.

12. A mixing or grinding cooking appliance comprising a drive device according to claim 1.

13. The cooking appliance according to claim 12, comprising a bowl and a lid suitable for closing the bowl, the drive device being contained in the lid.

14. The cooking appliance according to claim 12, comprising a removable food processing arm for mixing or grinding, the food processing arm being connected to the drive member of the drive device.

15. The drive device according to claim 9, wherein an actuator is adapted to position and hold the lever in the second position.

16. The cooking appliance according to claim 13, comprising a removable food processing arm for mixing or grinding, the food processing arm being connected to the drive member of the drive device.
